(19) United States
(12) Patent Application Publication
(10) Pub. No.: US 2009/0158394 A1
(43) Pub. Date: Jun. 18, 2009

(54) SUPER PEER BASED PEER-TO-PEER NETWORK SYSTEM AND PEER AUTHENTICATION METHOD THEREOF

(75) Inventors: Byeong-Thaek OH, Daejeon (KR); Sang-Bong Lee, Daejeon (KR); Ho-Jin Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATION RESEARCH INSTITUTE, Daejeon (KR)

(21) Appl. No.: 12/191,736

(22) Filed: Aug. 14, 2008

(30) Foreign Application Priority Data
Dec. 18, 2007 (KR) 10-2007-0133504

(51) Int. Cl. G06F 21/00

(52) U.S. Cl. 726/3

(57) ABSTRACT

Provided are a super peer based P2P network system and a peer authentication method thereof. The authentication method includes a first authentication process and a second authentication process. In the first authentication process, a user and a peer which want to use a P2P network are verified by submitting authentication information and a public key infrastructure (PKI) certificate, and receive the permission of connection. In the second authentication process, a user and a peer requesting the use of a specific service are authenticated by using an authentication ticket and a service access-permitted time is limited in order to reinforcing the security of the specific service, which is searched in the P2P network and provided by the peer. Accordingly, the service providers can verify users more securely and limit the service available time of each user with respect to a specific service provided by the peer by using the lifetime of the ticket.

### CROSS-REFERENCE TO RELATED APPLICATIONS

This application claims priority under 35 U.S.C. §119 to Korean Patent Application No. P2007-133504, filed on Dec. 18, 2007, the disclosure of which is incorporated herein by reference in its entirety.

### BACKGROUND OF THE INVENTION

1. Field of the Invention

The present disclosure relates to a peer-to-peer (P2P) network environment, and more particularly, to a super peer based P2P network system, which is capable of providing a high-reliability service through a secure user authentication, and a peer authentication method thereof.

This work was supported by the IT R&D program of MIC/IITA. [2006-S-068-02, Development of Virtual Home Platform based on Peer-to-Peer Networking]

2. Description of the Related Art

Generally, a P2P technology provides a technique capable of efficiently using a distributed network environment by depending on computation and bandwidth performance of equipments participating in network establishment rather than centralizing a distributed network environment into a few servers. According to the P2P technology, a peer participating in a communication network can communicate with other peer, without using Domain Name Service (DNS), and can provide the sharing of its own resources (e.g., storage, contents, computing resources, etc.). Since a peer can function as both a server and a client, its resources can be directly shared with other peer.

P2P networks can be classified into a pure P2P network and a hybrid P2P network in accordance with their configuration method. The pure P2P network is implemented using the P2P concept in itself, but has not drawn much interest due to its limitation of performance. The hybrid P2P network is vulnerable to failures because peers on the P2P network or important functions (e.g., a central server) for searching resources provided by the peers are excessively centralized into one location. On the other hand, the pure P2P network has a low performance because important functions are not centralized, as opposed to the hybrid P2P network.

Generally, a few peers having an excellent computer performance or excellent network environment are selected among a plurality of peers and designated as super peers, and the role of the central server of the hybrid P2P network is decentralized. According to the super peer based P2P network, when malfunction occurs in one super peer, other super peer can perform the function of the malfunctioned peer. Therefore, the super peer based P2P network can resolve the problem of the hybrid P2P network in which the network does not perform its function when an important peer is shut down. Furthermore, the super peer based P2P network can resolve the problem of the pure P2P network in which the performance is degraded because there is no server helping the searching operation. In spite of these advantages, the related art super peer based P2P network has security problems such as anonymous malicious attacks, unauthorized user's access to contents, or personal information leakage.

Furthermore, the P2P network service providers perform authentication simply using identifications (IDs) and passwords. Such an authentication method using IDs and passwords is susceptible to security and cannot provide a variety of limiting means.

### SUMMARY

Therefore, an object of the present invention is to provide a super peer based P2P network system, which is capable of enhancing the safety of service, and a peer authentication method of the super peer based P2P network system.

Another object of the present invention is to provide a super peer based P2P network system, which enables a service provider to verify users more securely, and a peer authentication method of the super peer based P2P network system.

Another object of the present invention is to provide a super peer based P2P network system, which is capable of limiting an available time of each user with respect to a specific service provided by a peer, and a peer authentication method of the super peer based P2P network system.

To achieve these and other advantages and in accordance with the purpose(s) of the present invention as embodied and broadly described herein, a peer authentication method of a super peer based peer-to-peer network system in accordance with an aspect of the present invention includes: requesting, by a super peer, an authentication of a peer requesting a service to an authentication server; verifying, by the authentication server, a user and a peer and registering the peer as a peer of the corresponding user; issuing, by the authentication server, a session key that will be used by the peer; adding, by the super peer, the peer to a connection-permitted peer list after the authentication succeeds; and permitting, by the super peer, the connection by transmitting the session key to the peer.

To achieve these and other advantages and in accordance with the purpose(s) of the present invention, a peer authentication method of a super peer based peer-to-peer network system in accordance with another aspect of the present invention includes: forming, by a peer, a virtual communication channel between the peer and other peer after the peer searches the other peer, and limiting the other peer's use of a specific service by checking a service access-permitted peer list when the other peer requests the use of the specific service; receiving, by the peer, an authentication ticket by requesting an authentication ticket issue to the super peer upon a request of the other peer; verifying, by the other peer, the issued authentication ticket and permitting the use of the specific service; and reissuing the authentication ticket for the service in order to limit an authentication ticket lifetime of each permitted user.

To achieve these and other advantages and in accordance with the purpose(s) of the present invention, a super peer based peer-to-peer network system in accordance with another aspect of the present invention includes: at least one peer for requesting a service, providing authentication information input by a user, and forming a virtual communication channel between the peer and other peer; at least super peer for checking a connection-permitted peer list, requesting an authentication of a peer that does not exist in the connection-permitted peer list, and adding an authenticated peer to the connection-permitted peer list; and an authentication server for authenticating a peer and user requested by a super peer, generating a session key, and issuing an authentication ticket to the requested peer.

To achieve these and other advantages and in accordance with the purpose(s) of the present invention, a peer authentication method of a super peer based peer-to-peer network system in accordance with another aspect of the present invention includes: performing a first authentication process to verify a peer requesting a service by using a certificate and permit a connection; and performing a second authentication process to authenticate a user and a peer requesting the use of a specific service, which is provided by a peer searched in a peer-to-peer network, by using an authentication ticket and limit a service access-permitted time.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates an architecture of a super peer based P2P network system according to an embodiment of the present invention;

FIG. 2 is a block diagram illustrating an internal structure of a peer according to an embodiment of the present invention;

FIG. 3 is a flowchart illustrating a process of authenticating a user and a peer which want to use a P2P network in the super peer based P2P network system according to an embodiment of the present invention;

FIG. 4 illustrates a format of an authentication information message according to an embodiment of the present invention; and

FIG. 5 is a flowchart illustrating a process of authenticating a user and a peer upon the use of a specific service in the peer authentication method of the super peer based P2P network system according to an embodiment of the present invention.

### DETAILED DESCRIPTION OF EMBODIMENTS

Hereinafter, specific embodiments will be described in detail with reference to the accompanying drawings. Like reference numerals refer to like elements throughout the drawings. In the following description, well-known functions or constructions are not described in detail since they would obscure the invention in unnecessary detail.

A plurality of peers and a plurality of super peers are present in an actual P2P network environment. The plurality of peers may be connected through one super peer. However, for convenience of explanation, it will be assumed herein that two peers are connected to different super peers in the P2P network environment.

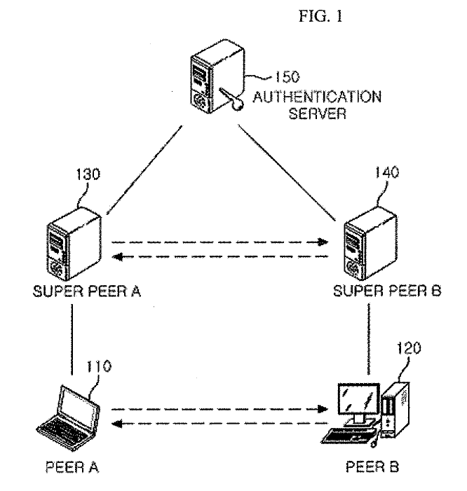

FIG. 1 illustrates an architecture of a super peer based P2P network system according to an embodiment of the present invention.

In the super peer based P2P network, a super peer propagates a message in order to search an edge peer and a resource of the edge peer. In addition, the super peer distributes indexing information that is indexed by the edge peer or the super peer itself in order for efficient search, as well as the message propagation.

Referring to FIG. 1, the super peer based P2P network system 100 according to the embodiment of the present invention includes a peer A 110, a peer B 120, a super peer A 130, a super peer B 140, and an authentication server 150. The peer A 110 and the peer B 120 generate and propagate advertisement messages, which notify IDs and information on resources (e.g., files or services) held by the peers 110 and 120, or search request messages. The super peer A 130 and the super peer B 140 distribute indexes assisting the message propagation and the resource search.

In order to use the P2P network environment, users of the peers 110 and 120 can be registered in the authentication server 150 by entering user information containing user IDs and passwords through the Internet.

The super peers 130 and 140 and the authentication server 150 are operated by a P2P network service provider, and a security communication may be established between the super peers 130 and 140 and the authentication server 150.

The peer may be each user's terminal, that is, a peer terminal, and the super peer may be a node relaying each peer terminal, that is, a relay server.

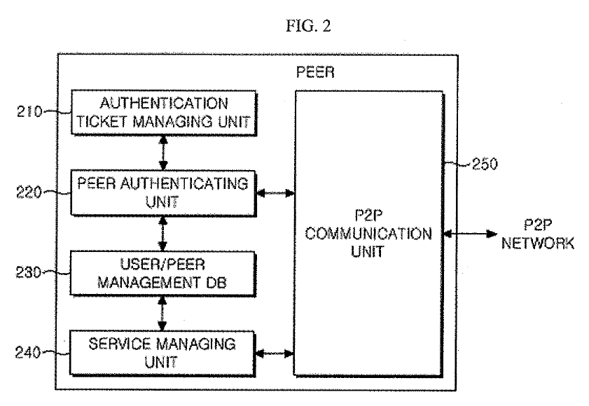

FIG. 2 is a block diagram illustrating an internal structure of the peer (the peer A 110 or the peer B 120) according to an embodiment of the present invention. Referring to FIG. 2, an authentication ticket managing unit 210 manages an ID of an authentication ticket provided from other peer, encrypts and decrypts the authentication ticket, and adjusts the lifetime of the authentication ticket for the service, thereby reissuing the authentication ticket again. A peer authenticating unit 220 encrypts and decrypts a message received from the super peer and other peer by using a session key, and entirely controls a peer authentication function. A user/peer management database (DB) 230 manages users who are permitted to use the services provided by the peers, and peer IDs of the permitted users. A service managing unit 240 manages IDs in each service provided by the peers, and notifies them to the P2P network. A P2P communication unit 250 entirely controls a P2P communication with the super peer(s) and other peer(s).

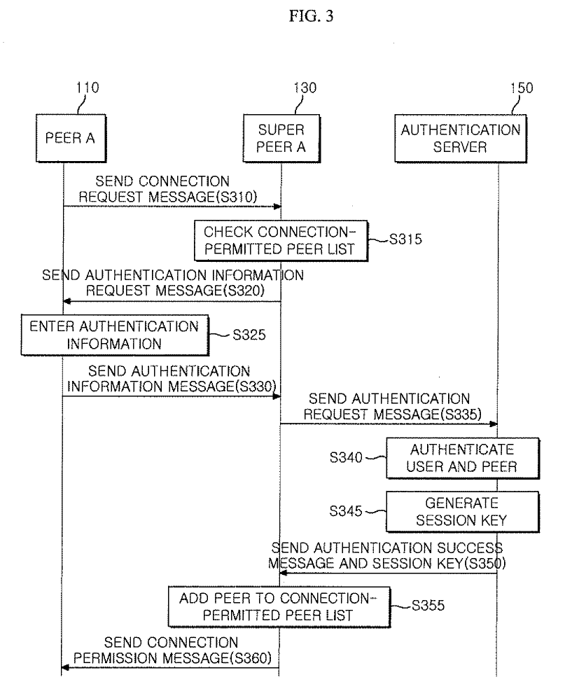

FIG. 3 is a flowchart illustrating a peer authentication method of the super peer based P2P network system according to an embodiment of the present invention. Specifically, FIG. 3 illustrates a first authentication process of authenticating a user and a peer which want to use the P2P network. The user may be authenticated by a certificate-based authentication method using a public key infrastructure (PKI) certificate. The user and the peer can also be authenticated by an ID/password-based authentication, in addition to the PKI-based authentication.

Referring to FIG. 3, when the user operates the peer A 110, the peer A 110 sends to the super peer A 130 a connection request message requesting a connection to the P2P network in operation S310.

In operation S315, the super peer A 130 receiving the connection request message checks if the peer A 110 sending the connection request message exists in a connection-permitted peer list of the super peer A 130.

When the peer A 110 does not exist in the connection-permitted peer list of the super peer A 130 in operation S315, the super peer A 130 sends an authentication information request message to the peer A 110 in operation S320.

In operation S325, when the peer A 110 receives the authentication information request message or does not its own session key, the peer A 110 provides the user with an interface for entering the authentication information, and the user can log in by entering a certificate password using the public key certificate through the interface.

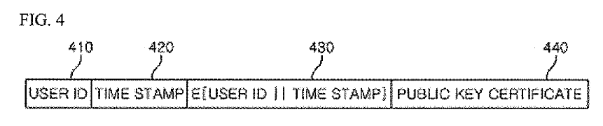

In operation S330, the peer A 110 sends to the super peer A 130 an authentication information message containing the user's authentication information. As illustrated in FIG. 4, the authentication information message may include a user ID 410, a time stamp 420, a digital signature 430 generated by encrypting the user ID and the time stamp with a secret key, and a public key certificate (PKC) 440. FIG. 4 illustrates a format of the authentication information message according to an embodiment of the present invention.

In operation S335, the super peer A 130 receiving the authentication information message sends an authentication request message to the authentication server 150. The authentication request message may be sent through a TCP/IP socket communication. The authentication request message may include user authentication information, such as the user ID, the time stamp, the digital signature encrypted with the secret key, and the public key certificate (PKC) contained in the authentication information message. In addition, the authentication request message may include the ID of the peer sending the authentication information message, that is, the ID of the peer A 110. When the peer A 110 exists in the connection-permitted peer list of the super peer A 130 in operation S315, the super peer A 130 notifies the successful authentication to the peer A 110, and sends the authentication request message created using the authentication information of the connection-permitted peer list.

In operation S340, the authentication server 150 receiving the authentication request message performs an authentication process on the corresponding user and the corresponding peer. That is, the authentication server 150 can verify the information contained in the authentication request message, for example, the user ID and the time stamp. In addition, the authentication server 150 can verify the digital signature using the public key certificate. The verification of the public key certificate may be performed by parsing, lifetime verification, and certification authority (CA) signature verification in this order. In addition, it can be checked if the ID of the peer requesting the authentication exists in the peer list. When the ID of the peer requesting the authentication does not exist in the peer list, the corresponding peer is registered as a new peer of a corresponding user in the peer list. On the other hand, when the ID of the peer requesting the authentication exists in the peer list, the authentication process is finished.

In operation S345, after the authentication succeeds, the authentication server 150 generates a one-time session key (K_{A}) that will be used by the peer A 110. The one-time session key (K_{A}) is encrypted with a public key and then transmitted to the peer A 110. Alternatively, the one-time session key (K_{A}) may be encrypted with a user's password.

In operation S350, the authentication server 150 transmits the authentication success message and the one-time session key (K_{A}) to the super peer A 130. The authentication success message and the one-time message (K_{A}) may be transmitted through a TCP/IP socket communication or a P2P message transmission.

In operation S355, the super peer A 130 receiving the authentication success message adds the peer A 110 to the connection-permitted peer list. In operation S360, the super peer A 130 sends the connection permission message containing the one-time session key (K_{A}) to the peer A 110.

The peer A 110 receiving the session key encrypted with the public key (or the user's password) can obtain its own session key (K_{A}) by decrypting the session key with the secret key of the peer A 110.

Meanwhile, upon the authentication process, when it is determined that the information contained in the authentication request message is improper, the authentication server 150 may notify the failed authentication to the peer A 110 through the super peer A 130. For example, the super peer A 130 may send an authentication failure message to the peer A 110.

The authentication process of the peer B 120 is identical to that of the peer A 110. When the authentication process is completed, the peer B 120 can also obtain a one-time session key (K_{B}) that will be used by the peer B 120 itself.

The peer A 110 and the peer B 120 having their own one-time session keys (K_{A}, K_{B}) can search the peers and the services using the P2P network provided by the super peer A 130 and the super peer B 140, and can also use the service provided by the respective peers.

In addition, when the peer requests a log-out to the super peer in order to terminate the use of the P2P network, the super peer can delete the corresponding peer from the connection-permitted peer list.

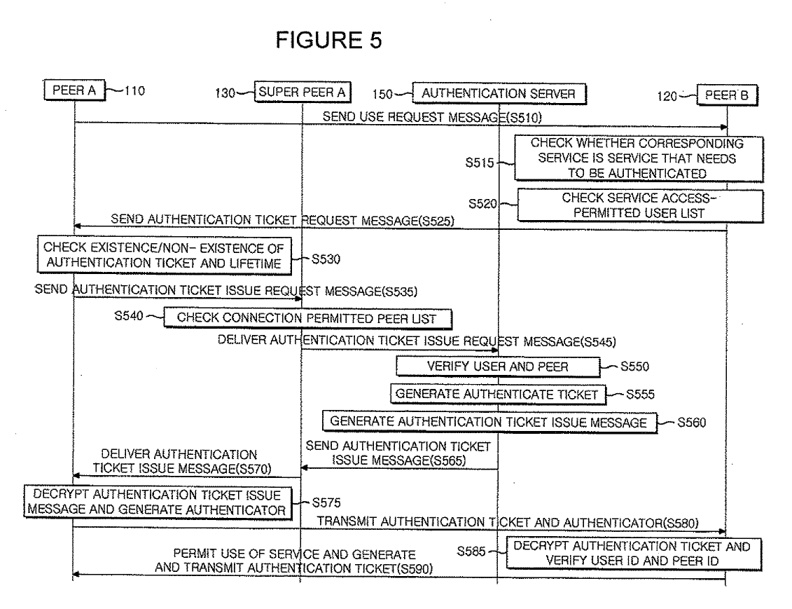

Meanwhile, when the peer wants to use resources, such as other peers or services, which are searched using the P2P network, a virtual communication channel is formed between the respective peers. After forming the virtual communication channel between the peers, when other peer requests the use of the service, the service may be opened to all peers. However, according to the embodiment of the present invention, the use of the service may be limited to a specific peer or during a specific period. This will be described below with reference to FIG. 5.

FIG. 5 is a flowchart illustrating a second authentication process of authenticating a user and a peer upon the use of a specific service in the peer authentication method of the super peer based P2P network system according to an embodiment of the present invention. It will be assumed herein that the peer A 110 searches the peer B 120 and the service of the peer B 120 through the super peers and the virtual communication channel is formed between the peer A 110 and the peer B 120.

In operation S510, the peer A 110 sends to the peer B 120 a service use request message requesting the use of the service (SID_{B}) of the peer B 120 through the virtual communication channel formed between the peer A 110 and the peer B 120.

In operation S515, the peer B 120 receiving the service use request message checks whether or not the corresponding service (SID_{B}) is a service that needs to be authenticated. When the corresponding service (SID_{B}) is a service that need not be authenticated, the use of the service of the peer A 110A can be permitted.

In operation S520, when the peer A 110 needs to be authenticated in order to provide the service only to a verified user for the purpose of security, the peer B 120 checks if the user ID of the peer A 110 exists in the service access-permitted user list. When the user ID of the peer A 110 does not exist in the service access-permitted user list, the peer B 120 sends a service refusal message to the peer A 110 and terminates the process.

In operation S525, when the user ID of the peer A 110 exists in the service access-permitted user list, the peer B 120 sends an authentication ticket request message to the peer A 110.

In operation S530, the peer A 110 receiving the authentication ticket request checks whether the authentication ticket exists or not and checks a ticket lifetime when the authentication ticket exists. In operation S535, when the authentication ticket does not exist or the lifetime of the authentication ticket is expired, the peer A 110 sends an authentication ticket issue request message to the super peer A 130. The authentication ticket issue request message may contain a user ID (UID_{A}) of the peer A 110, an ID (PID_{A}) of the peer A 110, a service ID (SID_{B}) of the peer B 120, which is requested by the peer A 110, an ID (PID_{B}) of the peer B 120, and a time stamp (TS₁) representing an authentication request time for preventing a replay attack.

In operation S540, the super peer A 130 checks if the peer A 110 still exists in the connection-permitted peer list. In operation S545, the super peer A 130 delivers the authentication ticket issue request message to the authentication server 150 when the peer A 110 exists in the connection-permitted peer list. At this point, the super peer A 130 may send the authentication ticket issue request message containing the user ID (UID_{A}) of the peer A 110, the ID (PID_{A}) of the peer A 110, the service ID (SID_{B}) of the peer B 120, which is requested by the peer A 110, the ID (PID_{B}) of the peer B 120, and the time stamp (TS₁) representing the authentication request time for preventing the replay attack.

In operation S550, the authentication server 150 receiving the authentication ticket issue request message from the super peer A 130 verifies the user ID (UID_{A}) of the peer A 110, and the ID (PID_{A}) of the peer A 110, which is held by the user. In operation S555, the authentication server 150 generates an authentication ticket (Ticket_{B1}) with respect to the service ID (SID_{B}) of the peer B 120, which is requested by the peer A 110. At this point, the authentication server 150 generates the authentication ticket (Ticket_{B1}) containing the user ID (UID_{A}) of the peer A 110, the ID (PID_{A}) of the peer A 110, the service ID (SID_{B}) of the peer B 120, which is requested by the peer A 110, the time stamp (TS₂) representing the ticket generation time, the authentication ticket ID (TID₁), and the lifetime (Lifetime₁) of the authentication ticket, together with the one-time session key (K_{A,B}) for secure communication between the peer A 110 and the peer B 120, and then encrypts the authentication ticket (Ticket_{B1}) with the session key (K_{B}) received by the user of the peer B 120, so that only the user of the peer B 120 can decrypt the encrypted authentication ticket (Ticket_{B1}).

In operation S560, the authentication server 150 adds the session key (K_{A,B}) between the peer A 110 and the peer B 120, the service ID (SID_{B}) of the peer B 120, the time stamp (TS₂) representing the generation time of the authentication ticket, and the lifetime (Lifetime₁) of the authentication ticket, together with the encrypted authentication ticket (Ticket_{B1}), and generates the authentication ticket issue message encrypted with the session key (K_{A}) of the user of the peer A 110, so that only the user of the peer A 110 can decrypt the encrypted authentication ticket issue message. In operation S565, the authentication server 150 sends the generated authentication ticket issue message to the super peer A 130 through the TCP/IP socket communication.

In operation S570, the super peer A 130 delivers the authentication ticket issue message, which is received from the authentication server 150, to the peer A 110 requesting the authentication ticket issue.

In operation S575, the peer A 110 decrypts the authentication ticket issue message using its own session key (K_{A}) to generate an authenticator (Authenticator_{A}) in order to confirm that the user of the peer A 110 who submits the ticket is an authorized user to whom the ticket is issued. The authenticator (Authenticator_{A}) encrypts information, which contains the user ID (UID_{A}) of the peer A 110, the ID (PID_{A}) of the peer A 110, and the time stamp (TS₃) representing the generation time of the authenticator (Authenticator_{A}), with the session key (K_{A,B}) between the peer A 110 and the peer B 120.

In operation S580, after generating the authenticator (Authenticator_{A}), the peer A 110 transmits the authentication ticket (Ticket_{B1}) received from the authentication server 150 and the authenticator (Authenticator_{A}) to the peer B 120 through the virtual communication channel.

In operation S585, the peer B 120 decrypts the authenticator (Authenticator_{A}) and the authentication ticket (Ticket_{B1}) with its own session key, and verifies the user ID and the peer ID. In operation S590, the peer B 120 rechecks if the user ID exists in the service access-permitted user list, and permits the user to use the corresponding service when the user ID exists in the service access-permitted user list. Then, the peer B 120 generates the authentication ticket (Ticket₂) by changing the time stamp (TS₂), the authentication ticket ID (TID₁), and the lifetime (Lifetime₁) of the authentication ticket, which are contained in the authentication ticket (Ticket_{B1}), into the time stamp (TS₄), the authentication ticket ID (TID₂), and the lifetime (Lifetime₂) of the authentication ticket, and decrypting the changed authentication ticket (Ticket_{B1}) with the session key of the peer B 120. The peer B 120 transmits the generated authentication ticket (Ticket_{B2}) to the peer A 110. The service available time can be limited using the ticket lifetime (Lifetime₂) with respect to the user IDs of the peers requesting the use of the corresponding service using the reissued authentication ticket (Ticket_{B2}).

When the user of the peer A 110 again uses the same service, the user of the peer A 110 can request the use of the service by submitting the authenticator (Authenticator_{A}) and the authentication ticket (Ticket_{B2}).

According to the embodiments of the present invention, the super peer based P2P network system and the peer authentication method thereof can verify the users and limit the service available time of each user with respect to a specific service provided by the peer by using the lifetime of the ticket.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A peer authentication method of a super peer based peer-to-peer network system, the peer authentication method comprising:
requesting, by a super peer, an authentication of a peer requesting a service to an authentication server;
verifying, by the authentication server, a user and a peer and registering the peer as a peer of the corresponding user;
issuing, by the authentication server, a session key that will be used by the peer;
adding, by the super peer, the peer to a connection-permitted peer list after the authentication succeeds; and
permitting, by the super peer, the connection, and transmitting the session key to the peer.

2. The peer authentication method of claim 1, wherein the requesting of the authentication comprises:
sending, by the peer, a connection request message to the super peer upon initial operation; and
checking, by the super peer, the connection-permitted peer list, notifying a successful authentication when the corresponding peer exists in the connection-permitted peer list, and receiving an authentication information message by requesting authentication information to the peer when the peer information does not exist in the connection-permitted peer list.

3. The peer authentication method of claim 2, wherein the authentication information message comprises a user ID, a time stamp, a digital signature generated by encrypting the user ID and the time stamp with a secret key, and a public key certificate (PKC).

4. The peer authentication method of claim 1, wherein the issuing of the session key comprises:
generating, by the authentication server, a one-time session key that will be used by the peer;
encrypting the one-time session key with a public key, and transmitting the encrypted one-time session key to the peer; and
obtaining, by the peer, a session key by decrypting the encrypted one-time session key with a secret key of the peer.

5. The authentication method of claim 1, further comprising deleting, by the super peer, the peer information from the connection-permitted peer list of the super peer when the peer logs out in order to finish the use of a peer-to-peer network.

6. A peer authentication method of a super peer based peer-to-peer network system, the peer authentication method comprising:
forming, by a peer, a virtual communication channel between the peer and other peer after the peer searches the other peer, and limiting the peer's use of a specific service by checking a service access-permitted peer list when the peer requests the use of the specific service of the other peer;
receiving, by the peer, an authentication ticket by requesting an authentication ticket issue to the super peer upon a request of the other peer;
verifying, by the other peer, the issued authentication ticket and permitting the use of the specific service; and
reissuing, by the other peer, the authentication ticket for the service in order to limit an authentication ticket lifetime of each permitted user.

7. The peer authentication method of claim 6, wherein the limiting of the peer's use of the specific service comprises:
requesting, by the peer, the use of the specific service to the other peer after the service search is completed;
checking, by the other peer, a service access-permitted user and peer list with respect to the peer; and
refusing, by the other peer, to provide the service when the peer does not exist in the service access-permitted user and peer list, and requesting an authentication ticket to the peer in order to provide the service when the peer exists in the service access-permitted user and peer list.

8. The peer authentication method of claim 6, wherein the issuing of the authentication ticket comprises:
checking, by the peer, an existence/non-existence and lifetime of the authentication ticket with respect to the requested service;
requesting the use of the service using the authentication ticket when the authentication ticket exists and the lifetime of the authentication ticket is available;
requesting the authentication ticket issue with respect to the service to the super peer when the authentication ticket does not exist or the authentication ticket lifetime is expired;
determining, by the super peer, whether the peer information exists in a connection-permitted peer list, requesting a user and peer authentication when the peer information does not exist in the connection-permitted peer list, and requesting the authentication ticket issue to the authentication server when the peer information exists in the connection-permitted peer list; and
generating, by the authentication server, the authentication ticket and transmitting the generated authentication ticket to the peer.

9. The peer authentication method of claim 6, wherein the permitting of the specific service comprises:
receiving, by the peer, the authentication ticket from the super peer and decrypting the received authentication ticket with a session key of the peer, and generating an authenticator to request the use of the specific service to the other peer through a virtual communication channel; and
rechecking, by the other peer, the service access-permitted user list and verifying a user and a peer by decrypting the authentication ticket and the authenticator.

10. The peer authentication method of claim 6, wherein the reissuing of the authentication ticket comprises:
permitting the use of the service by verifying a user and a peer; and
reissuing the authentication ticket having an adjusted lifetime limiting the service access available time for the service of the peer by the peer providing the service.

11. The peer authentication method of claim 10, further comprising requesting the use of the service using the reissued authentication ticket when the peer uses the same service.

12. A super peer based peer-to-peer network system, comprising:
at least one peer for requesting a service, providing authentication information input by a user, and forming a virtual communication channel between the peer and other peer;
at least super peer for checking a connection-permitted peer list, requesting an authentication of a peer that does not exist in the connection-permitted peer list, and adding an authenticated peer to the connection-permitted peer list; and
an authentication server for authenticating a peer and user requested by a super peer, generating a session key, and issuing an authentication ticket to the requested peer.

13. The super peer based peer-to-peer network system of claim 12, wherein the peer comprises:
an authentication ticket managing unit for managing an ID of an authentication ticket submitted by other peer, encrypting and decrypting the authentication ticket, and reissuing an authentication ticket by adjusting an authentication ticket lifetime;
a peer authenticating unit for encrypting and decrypting a message received from the super peer and the other peer using the session key, and controlling a peer authentication function;
a user/peer management database for managing a user permitted to use the service provided by the peer, and a peer ID of the corresponding user;
a service managing unit for managing IDs in each service provided by the peers, and notifying the IDs to a peer-to-peer network; and
a peer-to-peer communication unit for controlling a peer-to-peer communication with the super peer(s) and the other peer(s).

14. A peer authentication method of a super peer based peer-to-peer network system, the peer authentication method comprising:
performing a first authentication process to verify a peer requesting a service by using a certificate and to permit a connection; and
performing a second authentication process to authenticate a user and a peer requesting the use of a specific service, which is provided by a peer searched in a peer-to-peer network, by using an authentication ticket and to limit a service access-permitted time for the peer requesting the use of the service.

15. The peer authentication method of claim 14, wherein the first authentication process comprises:
requesting, by a super peer, an authentication of the peer, which is requesting the use of a specific service, to an authentication server;
verifying, by the authentication server, the user and the peer and registering the peer as a peer of the corresponding user;
issuing, by the authentication server, a session key that will be used by the peer;
adding, by the super peer, the peer to a connection-permitted peer list after the authentication succeeds; and
transmitting, by the super peer, the session key to the peer to permit the connection.

16. The peer authentication method of claim 14, wherein the second authentication process comprises:
forming, by the peer, a virtual communication channel between the peer and other peer after the peer searches the other peer, and limiting, by the other peer, the peer's use of a specific service by checking a service access-permitted peer list when the peer requests the use of the specific service of the other peer;
receiving, by the peer, an authentication ticket by requesting an authentication ticket issue to the super peer upon a request of the other peer;
verifying, by the other peer, the issued authentication ticket and permitting the use of the specific service; and
reissuing the authentication ticket for the service in order to limit an authentication ticket lifetime of each permitted user.
